(19) United States
(12) Patent Application Publication
(10) Pub. No.: US 2025/0245049 A1
(43) Pub. Date: Jul. 31, 2025

(54) METHOD AND RELATED DEVICE FOR RESOURCE ALLOCATION

(71) Applicants: Beijing Zitiao Network Technology Co., Ltd., Beijing (CN); Lemon Inc., Grand Cayman (KY)

(72) Inventors: Ruidong PAN, Beijing (CN); Quan Meng, Beijing (CN); Hongwei Kang, Beijing (CN); Yuzhou Wang, Beijing (CN); Dongming Liu, Beijing (CN); Qinxin Wang, Beijing (CN); Yuan Feng, Singapore (SG); Jiawei Feng, Beijing (CN)

(21) Appl. No.: 19/039,759

(22) Filed: Jan. 28, 2025

(30) Foreign Application Priority Data
Jan. 29, 2024 (CN) 202410124985.2

(51) Int. Cl. G06F 9/50

(52) U.S. Cl. CPC G06F 9/5027

(57) ABSTRACT

Provided is a method for resource allocation, including: determining a constraint condition for a first parameter of each of items; giving, in a trained first parameter prediction model, different resource allocation conditions based on current performance data of each of the items, to predict a first parameter curve of each of the items under different resource allocation conditions; and allocating resources based on a constraint condition for the first parameter of the item and the first parameter curve. Based on the above method for resource allocation, the present disclosure further provides an apparatus, an electronic device, a storage medium, and a program product for resource allocation.

### CROSS REFERENCE

This application claims priority of Chinese Patent Application No. 202410124985.2, filed on Jan. 29, 2024, entitled ‘Method and Related Device for Resource Allocation’.

### FIELD

The present disclosure relates to the field of data processing technologies, and in particular, to methods and related devices for resource allocation.

### BACKGROUND

In the prior art, when allocating resources, an allocation range corresponding to the resources generally exists, and the allocation range includes a plurality of items, a single allocation range itself has a corresponding parameter indicator, and each item subordinate thereto also has a corresponding parameter indicator. However, in actual resource allocation, because of the difference between each item, the optimization target, magnitude and item performance of the corresponding parameters thereof are different. Therefore, during actual resource allocation, only whether each item complies with a corresponding parameter indicator is considered. It is difficult to allocate resources according to the parameter indicator of the allocation ranges.

In addition, in the process of allocating resources to items, there are generally three methods in the prior art. The first method is to summarize a resource allocation strategy through human experience, but this method relies on human experience, and it is not flexible enough, and lacks objectivity. The second method is to adjust resource allocation based on a proportional-integral-derivative control (PID) method. However, this method requires certain professional knowledge and experience when setting parameters of a proportional, an integral, and a derivative, and it cannot learn influences of other factors. The third method is to directly predict a result corresponding to the parameter under a given resource allocation condition, and adjust resource allocation according to the result. However, the number of target parameters during resource allocation may be more than one, and all resource allocation situations do not necessarily have a modelling condition, and adaptability is poor.

### SUMMARY

In view of this, the purpose of the present disclosure is to propose a method and a related device for resource allocation. When each resource is allocated, the allocation range and the parameter indicators corresponding to the item can be ensured at the same time. Furthermore, in the process of resource allocation, a change result of a parameter in the next period of time can be predicted, and resources of each item can be allocated more effectively based on the change result.

According to some embodiments of the present disclosure, the above-described method for resource allocation may comprise: determining a constraint condition for a first parameter of each of items; giving, in a trained first parameter prediction model, different resource allocation conditions based on current performance data of each of the items, to predict a first parameter curve of each of the items under different resource allocation conditions; and allocating resources based on a constraint condition for the first parameter of the item and the first parameter curve.

Based on the described method for resource allocation, an embodiment of the present disclosure provides an apparatus for resource allocation, comprising:
a determination module, configured to convert a constraint condition for a first parameter of the allocation range to a constraint condition of a first parameter of the item;
a prediction module, configured to give, in a trained first parameter prediction model, different resource allocation conditions based on current performance data of each of the items, to predict a first parameter curve of each of items under different resource allocation conditions;
an allocation module, configured to allocate resources based on a constraint condition for the first parameter of the item and the first parameter curve.

In addition, the embodiments of the present disclosure also provide an electronic device, comprising a memory, a processor, and a computer program stored on the memory and executable on the processor, wherein the program, when executed by the processor, implements the described method.

Embodiments of the present disclosure further provide a non-transitory computer readable storage medium storing computer instructions thereon, wherein the computer instructions are used for causing a computer to perform the described method.

Embodiments of the present disclosure also provide a computer program product comprising computer program instructions, wherein the computer program instructions, when executed on a computer, cause the computer to perform the described method.

The above-mentioned method and related device for resource allocation, comprising: determining a constraint condition for a first parameter of each of items; giving, in a trained first parameter prediction model, different resource allocation conditions based on current performance data of each of the items, to predict a first parameter curve of each of the items under different resource allocation conditions; allocating resources based on a constraint condition for the first parameter of the item and the first parameter curve. According to the embodiments of the present disclosure, when allocating resources, a constraint condition of a first parameter of each of the items is determined first, and then, when corresponding parameters of resource allocation is predicted, a change process of the parameter within a period of time can be predicted, i.e. a curve corresponding to the parameter, so that consumption of an operation resource of a model can be effectively reduced and corresponding data can be provided in a subsequent resource allocation process conveniently. In addition, in the embodiments of the present disclosure, resources are allocated in an automatic manner as a whole, which can effectively save the manpower of resource allocation.

### BRIEF DESCRIPTION OF THE DRAWINGS

To describe the technical solutions in the present disclosure or the related art more clearly, the following briefly introduces the accompanying drawings required for describing the embodiments or the related art. Apparently, the accompanying drawings in the following description show merely embodiments of the present disclosure, and a person of ordinary skill in the art may still derive other drawings from these accompanying drawings without creative efforts.

FIG. 1 shows an implementation flow of a method for resource allocation according to some embodiments of the present disclosure;

FIG. 2 shows a schematic diagram of an apparatus for resource allocation according to some embodiments of the present disclosure;

FIG. 3 shows a schematic diagram of a hardware structure of an electronic device according to an embodiment of the present disclosure.

### DETAILED DESCRIPTION

In order to make objects, technical solutions and advantages of the present disclosure more apparent, the present disclosure will be further described in detail below in conjunction with specific embodiments and with reference to the accompanying drawings.

It should be noted that, unless otherwise defined, technical terms or scientific terms used in the embodiments of the present disclosure should have a common meaning understood by those skilled in the art. The terms ‘first’, ‘second’, and the like used in the embodiments of the present disclosure do not indicate any order, quantity, or importance, but are only used to distinguish different components. Words of “comprising” or “including” and the like mean that the element or item before the word appears to encompass the element or item listed after the word and equivalents thereof, without excluding other elements or items. Words such as “connected” or “in connection” are not limited to physical or mechanical connections, but may include electrical connections, whether direct or indirect. The terms “upper”, “lower”, “left”, “right” and the like are only used for representing the relative position relationship, and when the absolute position of the described object changes, the relative position relationship may also change correspondingly.

It should be understood that, before the technical solutions of the embodiments of the present disclosure are used, the user is notified of the type, usage range, usage scenario, and the like of the concerned personal information in an appropriate manner, and the authorization of the user is obtained.

For example, in response to receiving an active request from a user, prompt information is sent to the user so as to explicitly prompt the user that an operation requested by the user needs to acquire and use personal information of the user. Thus, the user can select, according to the prompt information, whether to provide personal information for software or hardware such as an electronic device, an application program, a server, or a storage medium that executes the operations of the technical solutions of the present disclosure.

As an optional but non-limiting implementation, in response to receiving an active request of a user, a manner of sending prompt information to the user may be, for example, a manner of a pop-up window, where the pop-up window may present the prompt information in a text manner. In addition, the popup window may also carry a selection control for the user to select ‘agree’ or ‘don't agree’ to provide personal information to the electronic device.

It can be understood that, the above processes of notifying and obtaining the user authorization are only illustrative, and do not limit the implementation of the present disclosure, and other methods meeting relevant law and legal regulations may also be applied to the implementation of the present disclosure.

As described above, in the prior art, when allocating resources, an allocation range generally exists, and a single allocation range includes a plurality of items, the allocation range itself has a corresponding parameter indicator, and each item subordinate thereto also has a corresponding parameter indicator. However, in actual resource allocation, because of the difference between each item, the optimization target, magnitude and item performance of the corresponding parameters thereof are different. Therefore, during actual resource allocation, only whether each item complies with a corresponding parameter indicator is considered. It is difficult to allocate resources according to the parameter indicators of the allocation ranges. In addition, in the process of allocating resources to items, there are generally three methods in the prior art. The first method is to summarize a resource allocation strategy through human experience, but this method relies on human experience, it is not flexible enough, and lacks objectivity. The second method is to adjust resource allocation based on a proportional-integral-derivative control (PID) method. However, this method requires certain professional knowledge and experience when setting parameters of a proportional, an integral, and a derivative, and cannot learn influences of other factors. The third method is to directly predict a result corresponding to parameters under a given resource allocation condition, and adjust resource allocation according to the result. However, the number of target parameters during resource allocation may be more than one, and all resource allocation situations do not necessarily have a modelling condition, and adaptability is poor.

To this end, some embodiments of the present disclosure provide a method for resource allocation. When allocating resources, firstly, a constraint condition for a first parameter of each of the items is determined, and then when predicting a corresponding parameter of a resource allocation, a change process of a parameter within a period of time, i.e. a curve corresponding to the parameter, can be predicted, so that consumption of the operation resource of a model can be effectively reduced, and corresponding data can be provided in a subsequent resource allocation process conveniently. In addition, in the embodiments of the present disclosure, resources are allocated in an automatic manner as a whole, which can effectively save the manpower of resource allocation.

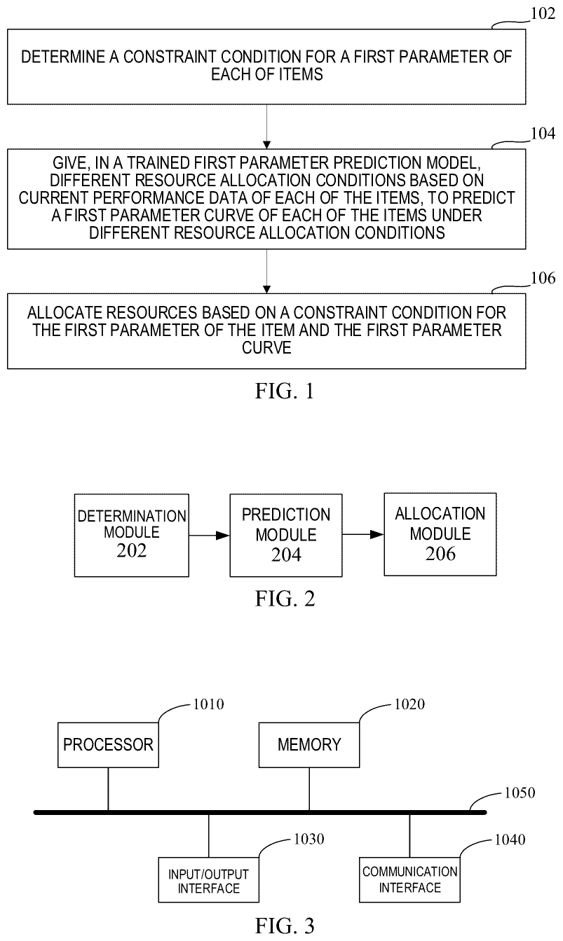

FIG. 1 shows an implementation flow of a method for resource allocation according to some embodiments of the present disclosure. As shown in FIG. 1, the method may include the following steps:

At step 102, determining a constraint condition for a first parameter of each of items.

In some embodiments of the present disclosure, determining the constraint condition for a first parameter of each of items comprises: determining an allocation range of each of the items; determining a constraint condition for a first parameter of the allocation range based on the allocation range; and decomposing the constraint condition for the first parameter of the allocation range based on a magnitude ratio corresponding to each of the items to obtain the constraint condition for the first parameter of each of the items.

In the embodiments of the present disclosure, when allocating resources, there may exist an allocation range, one allocation range may include a plurality of items, and each item has its own parameter indicators. Generally, a first parameter and a second parameter are used to embody a resource allocation result. After a certain amount of resources are allocated, the increase of the amount of first resources can be brought, but there is no necessary proportional relationship between the resources and the first resources. The first resource can also trigger the second resource, and likewise, there is no necessary proportional relationship between the two. The first resource only has the possibility of bringing about the second resource. The first parameter is generally a ratio between the amount of resources and the first resource, and the second parameter is generally a ratio between the second resource and the resource.

With regard to an allocation range, a first parameter of the allocation range is initially given a corresponding indicator, and in an actual situation, it is expected to obtain a higher amount of a first resource by means of fewer resource allocation, and therefore it is expected that a numerical value of the first parameter is lower, therefore, a foregoing constraint condition for the first parameter of the allocation range is that the first parameter of the allocation range is smaller than the indicator of the first parameter of the allocation range. However, in the prior art, an individual adjustment is generally made to each of the item under an allocation range, so that each of the item satisfies a corresponding parameter indicator. However, obviously, only the item is considered, and the constraint of the parameter indicator of the allocation range cannot be satisfied. Thus, in embodiments of the present disclosure, the constraint condition for the first parameter of the allocation ranges is converted into a constraint condition for the first parameter of the item. In this way, the constraint condition for the first parameter of the allocation range may be disassembled into a constraint condition for a first parameter of each one of the item. In this way, even though only a single item can be set when allocating resources, but after each one of the item is set, its allocation range will also naturally satisfies the constraint condition for the first parameter under the foregoing allocation range.

In addition, in this way, when resource allocation is subsequently performed on items, after independent items are enabled to satisfy the corresponding parameter constraint, the parameter constraint of an allocation range are naturally satisfied, thereby avoiding the occurrence of a situation in which the parameter constraint of an allocation range cannot be satisfied, and a resource allocation process still uses a single item as a unit, without adding other burdens.

In an embodiment of the present disclosure, the third resource can be obtained by calculating a ratio between the second resource and the first resource. In addition, because the value and the magnitude ratio of the third resource allocated to an item with a certain magnitude are relatively smooth within a period of time. Corresponding information may be acquired in real time by means of statistics, and may also be obtained by performing estimation through some pre-determined algorithms. The predetermined algorithm herein may be a sliding average algorithm or a linear model. Therefore, the constraint condition for the first parameter of the allocation range may be decomposed according to the magnitude ratio corresponding to each of the items, and the magnitude ratio herein may be the magnitude ratio of the first resource of the item.

In some embodiments of the present disclosure, the constraint condition for the first parameter of each of the item comprises: a sum of a product of the first parameter of each of the items and the magnitude ratio corresponding to each of the items being less than a first threshold.

In an embodiment of the present disclosure, the constraint condition for the first parameter of the item may be represented by the following formula:

$${{\sum }_{{Item}_{i}}}^{N} ( Magnitude {Ratio}_{{Item}_{i}} \times Third {Parameter}_{{Item}_{i}} ) \leq First Threshold$$

wherein, N indicates the number of items.

In some embodiments of the present disclosure, the first threshold is calculated by the following method: merging an indicator of the first parameter of the allocation range and an indicator of a second parameter of the allocation range to obtain an indicator of a third parameter of the allocation range; using a minimum value of the indicator of the first parameter of the allocation range and the indicator of the third parameter of the allocation range as the first threshold.

In embodiments of the present disclosure, based on the foregoing statements, it can be seen that a first parameter is a ratio between the resource and a first resource, the second parameter is a ratio between the second resource and the resource, and by combining the calculation formula of the first parameter and the second parameter, the two can be merged and converted into a first parameter which is the ratio between the second resource and the first resource, divided by the second parameter. In order to avoid confusion with the foregoing calculation method of the first parameter, the first parameter obtained by the subsequent merging is referred to as a third parameter. The foregoing calculation steps all use an allocation range. Certainly, calculation methods for the first parameter, the second parameter, and the third parameter of the item are the same as those in the foregoing description, and details are not repeatedly described herein, as long as the formula are replaced correspondingly. The reason why the first parameter and the second parameter are merged in the aforementioned steps is that, in the prior art, the allocation of the resource is adjusted according to the values of the first parameter and the second parameter. However, it is difficult to adjust the allocation of the resource based on the two types of parameters, since two parameters need to be controlled at the same time to fall into the corresponding indicators. However, in the present disclosure, a first parameter and a second parameter are merged to obtain a new expression manner of the first parameter, or in other words, expressing the first parameter by using the second parameter, and finally, the third parameter is obtained. Further, in a subsequent resource allocation adjustment process, it is only required to satisfy a constraint condition that it is less than the first threshold, because the first threshold is a minimum value between the first parameter indicator and the third parameter indicator, and the third parameter indicator is related to the second parameter. The first parameter indicator is a first parameter indicator of the allocation range itself, and since a minimum value is selected from the two parameters, it is equivalent that the condition of satisfying the two parameter indicators at the same time, that is, the constraint condition for the first parameter of the item is satisfied. It facilitates the subsequent adjustment of resource allocation, and can effectively reduce the difficulty of the adjustment of resource allocation. In addition, the reason why that the second parameter is used to represent the first parameter, or to finally actually adjust the calculation manner of the first parameter, is because the first parameter has higher timeliness than the second parameter, so that the feedback information obtained after the corresponding resource allocation can be collected more timely.

In step 104, giving, in a trained first parameter prediction model, different resource allocation conditions based on current performance data of each of the items, to predict a first parameter curve of each of the items under different resource allocation conditions.

In the embodiment of the present disclosure, the main idea of the first parameter prediction model is to predict a change trend of a first parameter of each of the items under different resource allocation conditions according to current performance data of the item and the predetermined different resource allocation conditions, which is embodied in the form of a first parameter curve.

The foregoing resource allocation condition may include a plurality of resource allocation conditions, and in specific implementation, different types of resources may exist in embodiments of the present disclosure, when the prediction on a first parameter is performed, the change trend of the first parameter under a plurality of allocation conditions can be viewed by setting allocation conditions of a plurality of different resources. In addition, in the embodiments of the present disclosure, it is not necessary to directly obtain a specific numerical value of the first parameter under a certain allocation. However, it is necessary to obtain the change trend under different allocation conditions, and therefore, for a scenario with a plurality of resources, comparing with the solution of obtaining the corresponding result through direct prediction, the technical solution of the embodiment of the present disclosure is more flexible, and accurate. Because if the results are predicted directly, it can be difficult and confusing to actually implement when there are a plurality of parameters. Furthermore, since there are too many possibilities, it is also difficult to finally feed back a corresponding resource allocation scheme based on a prediction result. However, in the embodiments of the present disclosure, a first parameter curve is directly obtained, and each curve corresponds to a type of resource allocation condition. When the resource allocation scheme is fed back, the resource allocation condition corresponding to the optimal solution can be directly found from all the curves.

In addition, because the sensitivities between the items are different, even if the object of the final first parameters between items are the same, the results may also be caused by different resource allocation conditions, therefore, when the first parameter curve is obtained, the first parameter curves of each item needs to be predicted, and are needed to be based on different resource allocation conditions.

In some embodiments of the present disclosure, the trained first parameter prediction model is trained by the following method: obtaining historical performance data, a historical resource allocation condition and a historical first parameter curve of an item; inputting the historical performance data into a first parameter prediction model to be trained, and obtaining a first parameter curve for training based on the historical resource allocation condition; training, based on the first parameter curve for training and the historical first parameter curve, the first parameter prediction model to be trained to obtain the trained first parameter prediction model.

In the embodiments of the present disclosure, the first parameter prediction model may be various machine learning models such as a gradient boosted tree and a neural network, and the modeling idea may refer to a thought in causal inference, and use a resource allocation condition as an intervention condition to predict the future change of the first parameter of the item.

When training the first parameter prediction model, the first parameter prediction model to be trained can be trained by obtaining historical performance data, a historical resource allocation condition and a historical first parameter curve. The historical performance data is the current relevant parameter before the historical resource allocation condition is applied, for example, the current resource allocation situation, a first parameter value, etc. A first parameter curve for training is obtained through prediction by inputting the historical performance data and the historical allocation condition to the first parameter model to be trained. The first parameter curve for training is a first parameter curve result obtained through direct prediction by a first parameter prediction model to be trained. It is necessary to calculate a related loss between the first parameter curve result and a true value, that is, the foregoing historical first parameter curve, and then train the first parameter model to be trained by using the loss, until a difference value between a predicted first parameter curve result and a historical first parameter curve result is less than a pre-determined threshold value. In this case, the first parameter model to be trained may be converted into a trained first parameter prediction model.

At step 106, allocating resources based on a constraint condition for the first parameter of the item and the first parameter curve.

In some embodiments of the present disclosure, allocating the resources based on the constraint condition for the first parameter of the item and the first parameter curve comprises: selecting, from the first parameter curves of each of the items under different resource allocation conditions, a first parameter of each of the items conforming to a first condition and a resource allocation condition corresponding to the first parameter based on the constraint condition for the first parameter of the item; calculating, based on the resource allocation condition for each of the items, a first resource allocation value of each of the items; allocating the resources based on the first resource allocation value of each of the items.

In the embodiments of the present disclosure, when allocating resources, the allocation may be directly performed based on a constraint condition for a first parameter of an item and a first parameter curve. That is, the first parameter that satisfies the first condition in each of the items and the resource allocation condition corresponding to the first parameter in each of the items may be directly selected from the first parameter curve. After the corresponding resource allocation condition is obtained, the resources of each of the items may be allocated accordingly. The first parameter curve can well reflect a relationship between a resource allocation condition and a corresponding value of the first parameter, and therefore, a corresponding resource allocation condition can be directly determined from the first parameter curve only by determining a first parameter value conforming to the first condition.

In some embodiments of the present disclosure, the first condition comprises the first parameter of the item satisfying the constraint condition for the first parameter of the item and the first parameter of the item is close to an indicator of a third parameter of the item.

In embodiments of the present disclosure, the constraint condition for a first parameter of an item have been described in the foregoing steps, and are not described herein again.

With regard to an indicator of a third parameter of an item, in some embodiments of the present disclosure, the indicator of the third parameter of the item is calculated by means of the following method: merging an indicator of a first parameter and an indicator of a second parameter of an item to obtain the indicator of the third parameter of the item.

Specifically, reference may be made to the step of calculating the third parameter indicator of the allocation ranges, which is similar to the foregoing step, and therefore is not repeated herein.

In the foregoing embodiment, the first parameter satisfying the condition for each item and the corresponding resource allocation condition may be obtained directly from the first parameter curve, and then the resources may be allocated directly based on the resource allocation condition.

However, for each item, a similar effect may be achieved under different resource allocation conditions, and in the foregoing steps, it is only required that each item satisfies a constraint condition and the indicator corresponding to each item, but the sensitivity of each item is different.

Therefore, the embodiments of the present disclosure further provides a method for resource allocation. During resource allocation, additionally, considering that under the premise of satisfying the aforementioned constraint conditions, the resource allocation may be further optimized.

In some embodiments of the present disclosure, allocating the resources based on the constraint condition for the first parameter of the item and the first parameter curve comprises: converting the first parameter curve of each of the items to obtain a resource curve of each of the items; calculating a second resource allocation value of each of the items based on the constraint condition for the first parameter of the item, the resource, the resource curve of each of the items and a predetermined state transfer equation; allocating the resources based on the second resource allocation value of each of the items.

In the embodiment of the present disclosure, specifically, the total value of the resources to be allocated this time may be confirmed first, and then the first parameter curve is directly converted into a resource curve according to the first parameter curve obtained in the foregoing step (it is described in the foregoing step that the first parameter is a ratio between the resource and the first resource, and therefore corresponding conversion may be performed), and the resource curve may reflect a relationship between an allocation value of the resource and the first resource.

A state DP_{i,j} is then defined, i representing the ith term, j representing the resource value, DP_{i,j}representing the maximum value of the first resource that can be obtained under the given aforementioned conditions.

Then, a state transfer equation is constructed, and the state transfer equation can describe a relationship between states. In an embodiment of the present disclosure, the state transfer equation is as follows:

$$D {P}_{i , j} = max ( D {P}_{i - 1 , j} , {DP}_{i - 1 , j - k} + {b}_{i , k} )$$

wherein k denotes a resource value allocated to the ith item, and b_{i,k} denotes a value of a first resource when k units of resource is allocated to the ith item.

Then determining the maximum and minimum resource values of each item, and then starting a reverse tracking from the DP_{n,B} to find an optimal resource allocation value of each item, i.e. the described second resource allocation value, n representing the total number of items and B representing the total resource value, and then allocating a resource based on the second resource allocation value.

The foregoing method for resource allocation: determining a constraint condition for a first parameter of each of items; giving, in a trained first parameter prediction model, different resource allocation conditions based on current performance data of each of the items, to predict a first parameter curve of each of the items under different resource allocation conditions; allocating resources based on a constraint condition for the first parameter of the item and the first parameter curve. In the embodiments of the present disclosure, when allocating resources, a constraint condition for a first parameter under an allocation range is first disassembled to be a constraint condition for a first parameter under an item. In this way, when resource allocation is subsequently performed on an item, after an independent item satisfies a corresponding parameter constraint, the parameter constraint of the allocation range is naturally satisfied as well, thereby avoiding the situation that the parameter constraint of the allocation range cannot be satisfied. Furthermore, the resource allocation process still uses a single item as a unit, without adding other burdens. In addition, when the corresponding parameter of the resource allocation is predicted, a change process of a parameter within a period of time, i.e. a curve corresponding to the parameter, can be predicted, so that consumption of an operation resource of a model can be effectively reduced, and corresponding data can be provided in a subsequent resource allocation process conveniently. In addition, in the embodiments of the present disclosure, resources are allocated in an automatic manner as a whole, which can effectively save the manpower of resource allocation.

It should be noted that the method according to the embodiments of the present disclosure may be executed by a single device, such as a computer or a server. The method in this embodiment may also be applied to a distributed scenario, and multiple devices cooperate with each other to complete the method. In this distributed scenario, one of the multiple devices may execute only one or more steps in the method according to the embodiment of the present disclosure, and the multiple devices interact with each other to implement the method.

It should be noted that some embodiments of the present disclosure have been described above, and other embodiments are within the scope of the appended claims. In some cases, the actions or steps recited in the claims may be performed in a different order than in the embodiments described above and still achieve desirable results. In addition, the processes depicted in the figures do not necessarily require the particular order shown, or sequential order, to achieve desirable results. In certain embodiments, multitasking and parallel processing may also or may be advantageous.

Based on the same inventive concept, corresponding to the method of any embodiment, the present disclosure further provides an apparatus for resource allocation.

Referring to FIG. 2, the apparatus for resources allocation comprises:
a determination module 202, configured to determine a constraint condition for a first parameter of each of items;
a prediction module 204, configured to give, in a trained first parameter prediction model, different resource allocation conditions based on current performance data of each of the items, to predict a first parameter curve of each of items under different resource allocation conditions;
an allocation module 206, configured to allocate resources based on a constraint condition for the first parameter of the item and the first parameter curve.

In some embodiments of the present disclosure, the determination module 202 comprises:
a first determination unit, configured to determine an allocation range of each of the items;
a second determination unit, configured to determine a constraint condition for the first parameter of the allocation range based on the allocation range;
a decomposition unit, configured to decompose the constraint condition for the first parameter of the allocation range based on a magnitude ratio corresponding to each of the items to obtain the constraint condition for the first parameter of each of the items.

In some embodiments of the present disclosure, the constraint condition for the first parameter of the item comprises: a sum of a product of the first parameter of each of the items and the magnitude ratio corresponding to each of the items being less than a first threshold.

In some embodiments of the present disclosure, further comprising:
a merging module, configured to merge an indicator of the first parameter of the allocation range and an indicator of a second parameter of the allocation range to obtain an indicator of a third parameter of the allocation range; and
a first threshold module, configured to use a minimum value of the indicator of the first parameter of the allocation range and the indicator of the third parameter of the allocation range as the first threshold.

In some embodiments of the present disclosure, further comprising:
an obtaining module, configured to obtain historical performance data, a historical resource allocation condition and a historical first parameter curve of an item;
an input module, configured to input the historical performance data into a first parameter prediction model to be trained, and obtaining a first parameter curve for training based on the historical resource allocation condition;
a training module, configured to train, based on the first parameter curve for training and the historical first parameter curve, the first parameter prediction model to be trained to obtain the trained first parameter prediction model.

In some embodiments of the present disclosure, the allocation module 206 comprises:
a selection unit, configured to select, from the first parameter curves of each of the items under different resource allocation conditions, a first parameter of each of items conforming to a first condition and a resource allocation condition corresponding to the first parameter based on the constraint condition for a first parameter of the item;
a first calculation unit, configured to calculate, based on the resource allocation condition for each of the items, a first resource allocation value of each of the items;
a first allocation unit, configured to allocating the resources based on the first resource allocation value of each of the items.

In some embodiments of the present disclosure, the first condition comprises the first parameter of the item satisfying the constraint condition for the first parameter of the item and that the first parameter of the item is close to an indicator of a third parameter of the item.

In some embodiments of the present disclosure, further comprising:
a merging module, configured to merge an indicator of a first parameter and an indicator of a second parameter of the item to obtain the indicator of the third parameter of the item.

In some embodiments of the present disclosure, the allocation module further comprises:
a converting unit, configured to convert the first parameter curve of each of the items to obtain a resource curve of each of the items;
a second calculation unit, configured to calculate a second resource allocation value of each of the items based on the constraint condition for the first parameter of the item, the resource, the resource curve of each of the items and a predetermined state transfer equation; and
a second allocation unit, configured to allocate the resources based on the second resource allocation value of each of the items.

For ease of description, the foregoing apparatus is described by dividing functions into various modules for separate description. Definitely, when the present disclosure is implemented, functions of each module may be implemented in one or more pieces of software and/or hardware.

The apparatus in the foregoing embodiment is configured to implement the corresponding resource allocation method in any one of the foregoing embodiments, and has beneficial effects of the corresponding method embodiment, which are not described herein again.

Based on the same inventive concept, corresponding to the method of any of the described embodiments, the present disclosure further provides an electronic device, comprising a memory, a processor and a computer program stored in the memory and operable on the processor, wherein when executing the program, the processor performs the method for resource allocation of any of the described embodiments.

FIG. 3 is a schematic structural diagram of hardware of a more specific electronic device according to this embodiment. The device may include: a processor 1010, a memory 1020, an input/output interface 1030, a communication interface 1040, and a bus 1050. The processor 1010, the storage 1020, the input/output interface 1030, and the communication interface 1040 are connected to each other inside the device through the bus 1050.

The processor 1010 may be implemented by using a universal CPU (Central Processing Unit), a microprocessor, an application specific integrated circuit (ASIC), or one or more integrated circuits, and is configured to execute a relevant program, so as to implement the technical solutions provided in the embodiments of the specification.

The memory 1020 may be implemented in the form of a ROM (Read Only Memory), a RAM (Random Access Memory), a static storage device, and a dynamic storage device. The memory 1020 may store an operating system and other application programs. When the technical solutions provided in the embodiments of the present invention are implemented by software or firmware, related program codes are stored in the memory 1020 and invoked and executed by the processor 1010.

The input/output interface 1030 is configured to connect to an input/output module to input and output information. The input/output module may be configured in a device (not shown in the figure) as a component, and may also be externally connected to the device to provide corresponding functions. The input device may include a keyboard, a mouse, a touch screen, a microphone, various sensors, and the like, and the output device may include a display, a speaker, a vibrator, an indicator lamp, and the like.

The communication interface 1040 is configured to connect to a communications module (not shown in the figure), so as to implement communication and interaction between this device and another device. The communication module may implement communication in a wired manner (such as a USB and a network cable), and may also implement communication in a wireless manner (such as a mobile network, WIFI, and Bluetooth).

The bus 1050 may comprise a pathway that may enable communication of information between various components of the device, for example, the processor 1010, the memory 1020, the input/output interface 1030, and the communication interface 1040.

It should be noted that, although the foregoing device only shows the processor 1010, the memory 1020, the input/output interface 1030, the communication interface 1040, and the bus 1050, in a specific implementation process, the device can further include other components necessary for implementing normal running. In addition, a person skilled in the art may understand that the foregoing device may also only include components necessary for implementing solutions of embodiments of the present specification, and does not necessarily include all components shown in the figure.

The electronic device in the foregoing embodiments is configured to implement the corresponding resource allocation method in any one of the foregoing embodiments, and has beneficial effects of the corresponding method embodiments, which are not described herein again.

Based on the same inventive concept, corresponding to the method of any of the above embodiments, the present disclosure further provides a non-transitory computer-readable storage medium, wherein the non-transitory computer-readable storage medium stores a computer instruction, and the computer instruction is used to enable the computer to execute the method for resource allocation described in any of the above embodiments.

The computer readable media of this embodiment, including both persistent and non-persistent, removable and non-removable media, may be any method or technology for storage of information. The information may be computer readable instructions, data structures, modules of a program, or other data. Examples of computer storage media include, but not limited to phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disc read-only memory (CD-ROM), digital versatile discs (DVD) or other optical storage, magnetic cassettes, magnetic tape magnetic disk storage or other magnetic storage devices, or any other non-transmission medium, may be used to store information that may be accessed by a computing device.

The computer instruction stored in the storage medium in the foregoing embodiment is used to enable the computer to execute the method for resource allocation in any one of the foregoing embodiments, and has beneficial effects of a corresponding method embodiment, which are not described herein again.

Based on the same inventive concept, corresponding to the resource allocation method described in any of the above embodiments, the present disclosure further provides a computer program product, comprising computer program instructions. In some embodiments, the computer program instructions may be executable by one or more processors of a computer to cause the computer and/or the processors to perform the described method for resource allocation. Corresponding to the executor corresponding to each step in each embodiment of the method for resource allocation, the processor executing the corresponding step may belong to the corresponding executor.

The computer program product in the foregoing embodiment is used to enable the computer and/or the processor to execute the method for resource allocation in any one of the foregoing embodiments, and has beneficial effects of the corresponding method embodiments, which are not described herein again.

It should be understood by one of ordinary skill in the art that the discussion of any embodiment above is merely exemplary and is not intended to imply that the scope of the present disclosure, including the claims, is limited to these examples; In the concept of the present disclosure, the technical features in the above embodiments or different embodiments may also be combined, the steps may be implemented in any order, and there are many other variations on different aspects of the embodiments of the present disclosure as described above, which are not provided in detail for simplicity.

In addition, well-known power/ground connections to integrated circuit (IC) chips and other components may or may not be shown in the provided drawings for simplicity of illustration and discussion, and so as not to obscure embodiments of the present disclosure. Furthermore, the apparatus may be shown in block diagram form in order to avoid obscuring embodiments of the present disclosure, and this also takes into account the fact that specifics with respect to embodiments of these block diagram apparatus are highly dependent upon the platform on which the embodiments of the present disclosure are to be implemented (i.e., such detail should be well within purview of those skilled in the art). Where specific details (e.g., circuits) are set forth in order to describe example embodiments of the disclosure, it should be apparent to those skilled in the art that embodiments of the disclosure may be practiced without, or with variation of, these specific details. Therefore, these descriptions should be regarded as illustrative rather than restrictive.

Although the present disclosure has been described in conjunction with specific embodiments of the present disclosure, many alternatives, modifications, and variations of these embodiments will be apparent to those of ordinary skill in the art in light of the foregoing description. For example, other memory architectures (e. g., dynamic RAM (DRAM)) may use the discussed embodiments.

It is intended that embodiments of the present disclosure cover all such alternatives, modifications and variations as belong to the broad scope of the appended claims. Therefore, any omissions, modifications, equivalents and improvements made without departing from the spirit and principle of the embodiments of the present disclosure shall belong to the scope of protection of the present disclosure.

I/we claim:

1. A method for resource allocation, comprising:
determining a constraint condition for a first parameter of each of items;
giving, in a trained first parameter prediction model, different resource allocation conditions based on current performance data of each of the items, to predict a first parameter curve of each of the items under different resource allocation conditions; and
allocating resources based on a constraint condition for the first parameter of the item and the first parameter curve.

2. The method of claim 1, wherein determining the constraint condition for the first parameter of the item comprises:
determining an allocation range of each of the items;
determining a constraint condition for a first parameter of the allocation range based on the allocation range; and
decomposing the constraint condition for the first parameter of the allocation range based on a magnitude ratio corresponding to each of the items to obtain the constraint condition for the first parameter of each of the items.

3. The method of claim 1, wherein the constraint condition for the first parameter of the item comprises: a sum of a product of the first parameter of each of the items and a magnitude ratio corresponding to each of the items being less than a first threshold.

4. The method of claim 3, wherein the first threshold is calculated by the following:
merging an indicator of the first parameter of an allocation range and an indicator of a second parameter of the allocation range to obtain an indicator of a third parameter of the allocation range; and
using a minimum value of the indicator of the first parameter of the allocation range and the indicator of the third parameter of the allocation range as the first threshold.

5. The method of claim 1, wherein the trained first parameter prediction model is trained by the following:
obtaining historical performance data, a historical resource allocation condition and a historical first parameter curve of an item;
inputting the historical performance data into a first parameter prediction model to be trained, and obtaining a first parameter curve for training based on the historical resource allocation condition; and
training, based on the first parameter curve for training and the historical first parameter curve, the first parameter prediction model to be trained to obtain the trained first parameter prediction model.

6. The method of claim 1, wherein allocating the resources based on the constraint condition for the first parameter of the item and the first parameter curve comprises:
selecting, from respective first parameter curves of each of the items under different resource allocation conditions, a first parameter of each of the items conforming to a first condition and a resource allocation condition corresponding to the first parameter based on the constraint condition for the first parameter of the item;
calculating, based on the resource allocation condition for each of the items, a first resource allocation value of each of the items; and
allocating the resources based on the first resource allocation value of each of the items.

7. The method of claim 6, wherein the first condition comprises the first parameter of the item satisfying the constraint condition for the first parameter of the item and the first parameter of the item is close to an indicator of a third parameter of the item.

8. The method of claim 7, wherein the indicator of the third parameter of the item is calculated by the following:
merging an indicator of the first parameter and an indicator of a second parameter of an item to obtain the indicator of the third parameter of the item.

9. The method of claim 1, wherein allocating the resources based on the constraint condition for the first parameter of the item and the first parameter curve comprises:
converting the first parameter curve of each of the items to obtain a resource curve of each of the items;
calculating a second resource allocation value of each of the items based on the constraint condition for the first parameter of the item, the resource, the resource curve of each of the items and a predetermined state transfer equation; and
allocating the resources based on the second resource allocation value of each of the items.

10. An electronic device, comprising a memory, a processor, and a computer program stored on the memory and executable on the processor, wherein the program, when executed by the processor, implements a method for resource allocation, comprising:
determining a constraint condition for a first parameter of each of items;
giving, in a trained first parameter prediction model, different resource allocation conditions based on current performance data of each of the items, to predict a first parameter curve of each of the items under different resource allocation conditions; and
allocating resources based on a constraint condition for the first parameter of the item and the first parameter curve.

11. The electronic device of claim 10, wherein determining the constraint condition for the first parameter of the item comprises:
determining an allocation range of each of the items;
determining a constraint condition for a first parameter of the allocation range based on the allocation range; and
decomposing the constraint condition for the first parameter of the allocation range based on a magnitude ratio corresponding to each of the items to obtain the constraint condition for the first parameter of each of the items.

12. The electronic device of claim 10, wherein the constraint condition for the first parameter of the item comprises: a sum of a product of the first parameter of each of the items and a magnitude ratio corresponding to each of the items being less than a first threshold.

13. The electronic device of claim 12, wherein the first threshold is calculated by the following:
merging an indicator of the first parameter of an allocation range and an indicator of a second parameter of the allocation range to obtain an indicator of a third parameter of the allocation range; and
using a minimum value of the indicator of the first parameter of the allocation range and the indicator of the third parameter of the allocation range as the first threshold.

14. The electronic device of claim 10, wherein the trained first parameter prediction model is trained by the following:
obtaining historical performance data, a historical resource allocation condition and a historical first parameter curve of an item;
inputting the historical performance data into a first parameter prediction model to be trained, and obtaining a first parameter curve for training based on the historical resource allocation condition; and
training, based on the first parameter curve for training and the historical first parameter curve, the first parameter prediction model to be trained to obtain the trained first parameter prediction model.

15. The electronic device of claim 10, wherein allocating the resources based on the constraint condition for the first parameter of the item and the first parameter curve comprises:
selecting, from respective first parameter curves of each of the items under different resource allocation conditions, a first parameter of each of the items conforming to a first condition and a resource allocation condition corresponding to the first parameter based on the constraint condition for the first parameter of the item;
calculating, based on the resource allocation condition for each of the items, a first resource allocation value of each of the items; and
allocating the resources based on the first resource allocation value of each of the items.

16. The electronic device of claim 15, wherein the first condition comprises the first parameter of the item satisfying the constraint condition for the first parameter of the item and the first parameter of the item is close to an indicator of a third parameter of the item.

17. The electronic device of claim 16, wherein the indicator of the third parameter of the item is calculated by the following:
merging an indicator of the first parameter and an indicator of a second parameter of an item to obtain the indicator of the third parameter of the item.

18. The electronic device of claim 10, wherein allocating the resources based on the constraint condition for the first parameter of the item and the first parameter curve comprises:
converting the first parameter curve of each of the items to obtain a resource curve of each of the items;
calculating a second resource allocation value of each of the items based on the constraint condition for the first parameter of the item, the resource, the resource curve of each of the items and a predetermined state transfer equation; and
allocating the resources based on the second resource allocation value of each of the items.

19. A non-transitory computer readable storage medium storing computer instructions thereon, wherein the computer instructions are used for causing a computer to perform a method for resource allocation, comprising:
determining a constraint condition for a first parameter of each of items;
giving, in a trained first parameter prediction model, different resource allocation conditions based on current performance data of each of the items, to predict a first parameter curve of each of the items under different resource allocation conditions; and
allocating resources based on a constraint condition for the first parameter of the item and the first parameter curve.

20. The non-transitory computer readable storage medium of claim 19, wherein determining the constraint condition for the first parameter of the item comprises:
determining an allocation range of each of the items;
determining a constraint condition for a first parameter of the allocation range based on the allocation range; and
decomposing the constraint condition for the first parameter of the allocation range based on a magnitude ratio corresponding to each of the items to obtain the constraint condition for the first parameter of each of the items.
